(19) United States
(12) Patent Application Publication
(10) Pub. No.: US 2006/0067275 A1
(43) Pub. Date: Mar. 30, 2006

(54) Mobile network coverage

(75) Inventors: Xinjie Yang, Xinjiang Autonmous Region (CN); Rahim Tafazolli, Surrey (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: University of Surrey, Guildford (GB)

(21) Appl. No.: 10/954,853

(22) Filed: Sep. 30, 2004

(51) Int. Cl. H04Q 7/00

(52) U.S. Cl. 370/332

(57) ABSTRACT

A method for estimating cell coverage in a mobile telecommunications network. The method includes the steps of receiving signal quality and position information from the users of the network and using the information to calculate a coverage map. Update information is also received to update the coverage map. The estimated cell coverage can be used in radio resource allocation methods.

This invention relates to a method of estimating cell coverage in a mobile telecommunications network.

Cell coverage in a CDMA (Code Division Multiple Access) based mobile telecommunications network is highly irregular and varies with time as well as being heavily dependent on the variations in traffic and propagations. Cell coverage estimation in such a mobile telecommunications network, is difficult and in some cases may even be impossible.

In future mobile communication systems, the radio resources allocation should be fully adaptive to system dynamics such as propagation and traffic variations. The instantaneous estimation of cell coverage can potentially provide a new dimension for radio resource allocation strategies.

According to the invention there is provided a method of estimating cell coverage in a CDMA based mobile network, wherein said network includes at least one service cell and a number of active users, said method including the steps of: defining a grid by dividing the area covered by said at least one service cell into a regular pattern of sub-cells; receiving information at said at least one service cell on the position of each of said active users relative to said grid; receiving information at said at least one service cell on the received signal quality of each of said active users; using said signal quality and position information received for all of said active users to calculate a cell coverage map for said at least one service cell receiving updated position and signal quality information at said cell coverage map according to the updated position and signal quality information.

This method of estimating cell coverage in a mobile telecommunication network is automatic, the method is also completely transparent to the users of the mobile telecommunication network and the results obtained by the method can be updated fast enough to capture the system dynamics.

In the embodiment of the invention the method further includes the steps of using said received position information to determine a respective sub-cell of the grid within which each said active user is respectively located, storing the current signal quality information for each said active user with reference to the sub-cell determined for the respective active user, and forming said coverage map from signal quality information stored for at least some of said active users.

Also in the embodiment of the invention said received signal quality information is defined by a plurality of samples, and said coverage map is formed from a pre-determined proportion of said samples having a magnitude exceeding a pre-determined threshold.

In a preferred embodiment of the invention, said updated position and signal quality information received at said at least one service cell replaces said received position and signal quality information received earliest at said at least one service cell, and said cell coverage map is updated.

In this embodiment, said updated position and signal quality information is received at said at least one service cell at intervals of between 0.1 and 1.0 seconds, preferably at an interval of 0.5 seconds.

The method preferably includes the steps of using said cell coverage map to calculate a cell boundary and updating said cell boundary when said (fell coverage map is updated. Said cell boundary is calculated by applying an optimal boundary estimation scheme to said cell coverage map.

In preferred embodiments, the estimated cell coverage as calculated by the above described method can be used in radio resource allocation processes such as soft handover or a call admission control process.

An embodiment of the invention is now described, by way of example only, with reference to the accompanying figures in which:

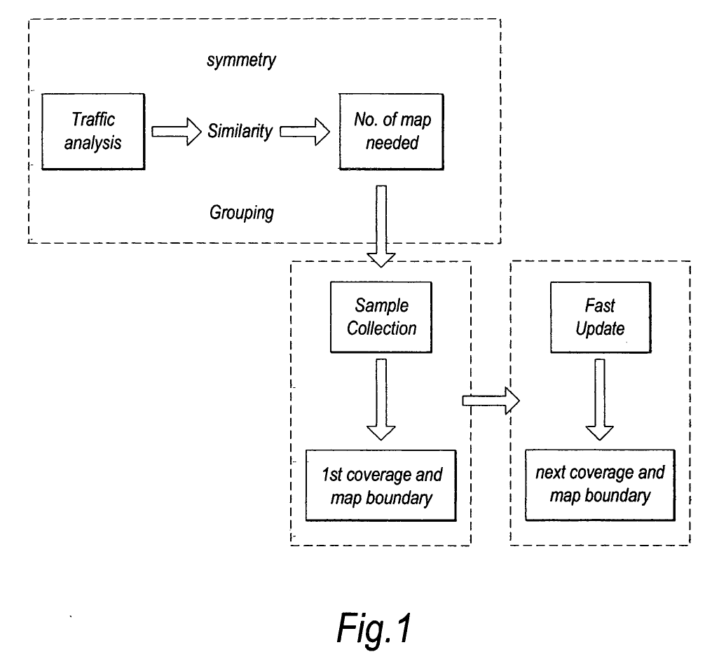

FIG. 1 is a block diagram showing the various stages in the proposed method of estimating cell coverage;

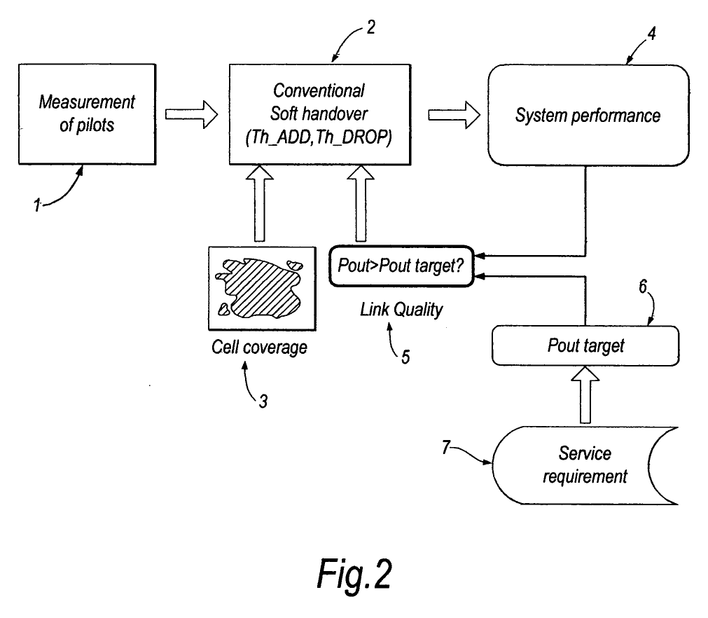

FIG. 2 is a block diagram of an adaptive soft handover process which uses the estimated cell coverage.

A mobile telecommunication network consists of at least one service cell (base station) and a number of active users of the network. The equipment of the active users, for example, a mobile handset, communicates with the service cell of the mobile telecommunication network.

In the mobile telecommunication network a cell coverage estimation algorithm is used to estimate the coverage of the service cell. The first stage in this estimation process is to divide the area covered by the service cell into a regular grid, defined by a regular pattern of sub-cells. The user's equipment of each of the active users of the telecommunication network report back their received signal quality and position within the grid to the service cell. The position of each of the active users with respect to the regular pattern of sub-cells is received at the service cell to determine within which sub-cell within the regular grid the active user is located. The signal quality reported by each of the active users within the grid will contribute a signal quality sample for the particular sub-cell of the grid in which the active user is located. This signal quality sample is used to calculate whether or not the sub-cell of the grid containing the active user is covered by the service cell, for example, if 95% (or any other set percentage) of the total reported signal quality samples for a particular sub-cell are higher than a specified target, the sub-cell is covered by the service cell. This acquisition of signal information and position information enables the service cell to relate the received signal quality information for each of the active users to particular sub-cells of the grid.

If enough measurement samples are received at the service cell the network can calculate its own cell coverage. According to the particular purpose that the cell coverage will be finally used for, the coverage can be estimated in two different ways. Firstly, by generating a cell coverage map and secondly, by generating a cell boundary. The cell boundary is calculated by applying an optimal boundary estimation scheme to the estimated cell coverage map. [Sharov A. A., E. A. Roberts, A. M. Liebhold, and F. W. Ravlin, “Gypsy moth (Lepidoptera: Lymantriidae) spread in the Central Appalachians; Three methods for species boundary estimation” Journal of Environmental Entomology, 24: pp. 1529-1538, December 1995.]

If this cell coverage estimation algorithm is applied to a 3G W-CDMA mobile network (Third Generation Wideband CDMA) it will not add any extra complexity to the network or to the user equipment, since the equipment used in this type of mobile telecommunication network has the capability of determining its position within the network and of measuring link quality. [3GPP, Functional stage 2 description of location services in UMTS, 3G TS 23.171, v3.0.0, 2000-03. 3GPP, Physical layer-Measurement (FDD), 3G TS 25.215 v3.0.0, 1999-10.]

The algorithm can be further broken down into a two-stage process. The first stage is collection of the data samples. In this case, the data samples are signal quality and user equipment position. This is a long-term process as the telecommunication network has to collect sufficient measurement samples to produce a first coverage map. The second stage in the process is the fast update of the coverage map. The coverage map is updated by replacing the most out of date measurement samples with the most recently acquired measurement samples. This updating of the map is performed at regular intervals. These intervals can be between 0.1-1.0 seconds but are typically 0.5 seconds.

In summary, the following steps are used in the calculation of the cell coverage map.
1) The active user equipment regularly reports back position and signal quality information to the service cell.
2) The service cell uses the received position information to determine which sub-cell of the regular grid the active user (with their equipment) is located in.
3) The signal information from the sub-cell determined in step (2) is stored by the service cell.
4) The service cell determines that a sub-cell of the grid is covered by the service cell, if a certain proportion (e.g. 95%) of the signal quality samples received at the service cell are higher than a pre-determined target.
5) The service cell uses to received signal quality and position information to calculate the cell coverage map.

A cell has to store a number of coverage maps for different time periods within a day, as the traffic varies greatly during the day.

By analyzing the traffic properties any symmetry or similarity of the traffic demands over a period of 24 hours, or any other specific time slot can be noted. This can then be used to reduce the number of coverage maps that need to be stored by the network.

The cell coverage calculated by the method described above can be used in various radio resource allocation schemes, such as soft handover or call admission control.

Soft handover is essential for intra-frequency handover in CDMA-based mobile communication systems such as UTRA (UMTS Terrestrial Radio Access) network [3GPP, Radio Resource Management Strategies, 3G TR 25.922, 1999-10.] When considering an adaptive soft handover algorithm which takes into account the estimated cell coverage, the adaptive thresholds/hystereses of the soft handover process can be constructed through a combination of the estimated cell coverage and link quality information. The estimated cell coverage helps to adjust the soft handover thresholds of the individual users by considering the cell coverage of both serving and target service cells, which provides a distributed way of constructing the adaptive soft handover thresholds. The link quality information, which may be a link outage probability, for example, is monitored and fed back to the soft handover process to dynamically adjust the soft handovers thresholds in order for the system to achieve desired link quality. This process provides a centralized way of adaptation. The combination of these two results in an adaptive soft handover process that can respond promptly to the system dynamics.

FIG. 2 is a block diagram showing an adaptive soft handover process which can use the cell coverage which has been estimated as described above.

The stages in a typical soft-handover process are now described.

The user equipment of an active user periodically measures the transmission on the pilot channel (1). The pilot channel is a channel which is continuously transmitting from a service cell to all the active users. An active user will be served by the service cell from which it has received the strongest pilot channel transmission.

The measurements of the transmission from the pilot channel obtained this way by each active user are passed to the conventional soft handover process (2). This soft handover process normally includes two thresholds; namely an adding threshold (Th-ADD) and a dropping threshold (Th-DROP). The link outage probability (Pout) of the resulting system performance (4, 5) is then fed back to the soft handover control process (2). The service requirement (7) will decide the particular link outage probability target (Pout-target) (6), as different services required by the user might have different link outage probability targets. The current link outage probability (Pout) will be compared to the desired target (Pout-target) and the comparison result is used to adjust the soft handover threshold (Th-ADD, Th-DROP). This method of control of the soft handover process is centralized, and it will adjust the thresholds for soft handover of all of the active users at the same time.

Cell coverage information (3) as calculated by the method previously described, will provide a factor to be considered in the adjustment of the soft handover thresholds for individual active users.

As mentioned above, the ordinary soft handover process is a centralized procedure, i.e. the thresholds of all of the active users are adjusted at the same time. The cell coverage information can be used to adjust the threshold of each active user individually. For example, there may be several active users located in different sub-cells of the grid. These users may all have different thresholds for the soft handover process. The cell coverage information as calculated for a particular sub-cell can be used to adjust the threshold for the active users in that particular sub-cell, but the thresholds for the active users in all of the other sub-cells are unaffected by this adjustment.

One of the important features of this soft handover algorithm is its robustness.

This means the algorithm can automatically achieve better optimization between radio resource efficiency and QoS (Quality of Service). The algorithm can achieve high resources efficiency, while at the same time guaranteeing the QoS, when the system is in good condition (e.g. low traffic load or small shadowing conditions). It can also prioritize the QoS in severe conditions (e.g. high traffic load or severe shadowing conditions).

The estimated cell coverage can also be applied to the call admission control process as well, particularly when a new call is originated near the cell boundary. In this case, the coverage information from multiple cells might be more accurate than the measurement of downlink pilot channels, as it is directly derived from the traffic channel as if the traffic channel has already been set up.

When a new call is generated, a service cell for that call is chosen by measuring the strongest signal from the pilot channels for all possible service cells. In this case, the estimated cell coverage map can provide extra information complementary to the pilot channel signal strength measurement. For example, if the user of the new call is located in a sub-cell of the grid which is not covered by the service cell with the strongest pilot channel measurement, the user equipment of the active user would be directed to use the service cell with the second strongest pilot channel measurement as the service cell. This is because the cell coverage information as estimated above, is derived directly for the traffic channel, and therefore, is more accurate then the pilot channel signal measurements, in determining which service cell the active user should use.

1. A method of estimating cell coverage in a CDMA based mobile network, wherein said network includes at least one service cell and a number of active users, said method including the steps of defining a grid by: dividing the area covered by said at least one service cell into a regular pattern of sub-cells; receiving information at said at least one service cell on the position of each of said active users relative to said grid; receiving information at said at least one service cell on the received signal quality of each of said active users; using said signal quality and position information received for all said active users to calculate a cell coverage map for said at least one service cell; receiving updated position and signal quality information at said at least one service cell and updating said cell coverage map according to the received updated position and signal quality information.

2. A method of estimating cell coverage according to claim 1 wherein said method further includes the steps of using said received position information to determine a respective sub-cell of the grid within which each said active user is respectively located, storing current signal quality information for each said active user with reference to the sub-cell determined for the respective active user, and forming said coverage map for signal quality information stored for at least some of said active users.

3. A method of estimating cell coverage according to claim 2 wherein said received signal quality information is defined by a plurality of samples, and said coverage map is formed from a predetermined proportion of said samples having a magnitude exceeding a predetermined threshold.

4. A method of estimating cell coverage according to any of claim 1 wherein said updated position and signal quality information received at said at least one service cell replaces said received position and signal quality information received earliest at said at least one service cell, and said cell coverage map is updated.

5. A method of estimated cell coverage according to claim 1 wherein said updated position and signal quality information is received at said at least one service cell at intervals of between 0.1 and 1.0 seconds.

6. A method of estimating cell coverage according to claim 5 wherein said interval is 0.5 seconds.

7. A method of estimating cell coverage according to claim 1 including the steps of: using said cell coverage map to calculate a cell boundary, and updating said cell boundary when said cell coverage map is updated.

8. A method of estimating cell coverage according to claim 7 wherein said cell boundary is calculated by applying an optimal boundary estimation scheme to said cell coverage map.

9. A method of radio resource allocation in a CDMA based mobile telecommunication network which uses said cell coverage as estimated by the method of claim 1.

10. A method of radio resource allocation according to claim 9 which uses said estimated cell coverage in a soft handover process.

11. A method of radio resource allocation according to claim 10 wherein said estimated cell coverage is used with link quality information to construct adaptive thresholds for said soft handover process.

12. A method according to claim 11 wherein said link quality information is a link outage probability.

13. A method according to claim 12 including the steps of:
monitoring said link outage probability; and dynamically adjusting said adaptive threshold in response to changes in said link outage probability.

14. A method of radio resource allocation according to claim 9 which uses said estimated cell coverage in a call admission control process.

15. A method of estimating cell coverage CDMA network according to claim 1 wherein the CDMA network is an MC-CDMA (Multi-carrier CDMA) based 49 network.

16. A method of estimating cell coverage according to claim 1 wherein said estimated cell coverage is used to optimize antenna down-tilting and/or dynamic cell sectorization.
